(19) United States
(12) Patent Application Publication
(10) Pub. No.: US 2001/0009725 A1
(43) Pub. Date: Jul. 26, 2001

(54) Heat-shielding method, coated product, and car upholstery

(76) Inventors: Makoto Moriyama, Kanagawa (JP); Yasuo Sato, Ibaraki (JP); Goro Nagao, Kanagawa (JP); Takamitsu Sawamura, Kanagawa (JP); Hiroyuki Ushioda, Kanagawa (JP); Kiyoshi Nomura, Kanagawa (JP); Katsuo Miki, Saitama (JP)

Correspondence Address: Jordan and Hamburg LLP, 122 East 42nd Street, New York, NY, 10168, US

(21) Appl. No.: 09/728,240

(22) Filed: Dec. 1, 2000

(30) Foreign Application Priority Data
Dec. 3, 1999 (JP) HEI-11-344-709
Dec. 3, 1999 (JP) HEI-11-344-711
Dec. 3, 1999 (JP) HEI-11-344-712

(51) Int. Cl. B32B 5/00; B05B 5/00

(52) U.S. Cl. 428/689; 428/98; 427/160

(57) ABSTRACT

This invention is related to a heat-shielding method which comprises disposing a thin plate having an IR-reflecting function adjacent to one side of a coated plate and disposing said coated plate in a position such that the surface adjacent to said thin plate is on the side not exposed to infrared light.

### TECHNICAL FIELD

The present invention relates to a heat-shielding method for preventing temperature buildup in closed spaces due to solar or other radiation and to a coated product as fabricated by said heat-shielding method. More particularly, the invention relates to a heat-shielding method and a coated product suitable for suppressing buildup of the interior temperature of automobiles. The present invention further relates to a car upholstery suited for prevention of buildup of the car interior temperature due to radiations such as solar rays.

### PRIOR ART

When a car is left under the blazing sun, its interior temperature rises. Operating the air conditioner to control this temperature rise results in an increased gas consumption and an increased exhaustion of CO₂ gas. The consumption of energy for prevention of temperature buildup takes place not only in automobiles but broadly in various buildings such as office buildings, homes and warehouses as well as in other vehicles such as aircraft and ships and amounts to an enormous proportion.

Under the circumstances, a variety of heat barrier coatings have been proposed as means for preventing the temperature rise without involving energy consumption; for example Japanese Kokoku Publication Sho-59-31545 discloses a heat-reflecting enamel containing a pigment such as nickel oxide, antimony trioxide and the like and JP 2593968 discloses a black solar heat-barrier coating composition which does not contain a heavy metal.

However, it is acknowledged that said heat-reflective enamel and solar heat barrier coating composition are by nature not effective unless they are used on the outermost surface of the substrate. There is the problem, therefore, that the assortment of coating compositions to chose from is limited for products in which design (appearance) is an important factor, particularly the passenger car or the like.

It is, therefore, an object of the present invention to provide a heat-shielding method capable of providing a heat-barrier effect even if a heat barrier coating is not applied to the outermost surface.

It is another object of the present invention to provide a coating film capable of expressing a heat-barrier effect even if not formed on the outermost surface.

It is still another object of the present invention to provide an upholstery having a heat-barrier function without compromise in the design quality of the outermost surface.

### SUMMARY OF THE INVENTION

Designed to accomplish the above objects, the first aspect of the present invention is directed to a heat-shielding method which comprises disposing a thin plate having an IR-reflecting function adjacent to one side of a coated plate and disposing said coated plate in a position such that the surface adjacent to said thin plate is on the side not exposed to infrared light. When the invention is applied to an automotive body, the thin plate having an IR-reflecting function is disposed adjacent to the inner side of the body. The inner side of the automotive body as the term is used in this specification means the interior space of the vehicle, the space within the bonnet, the compartment within the trunk and/or the like. As an example of said thin plate having an IR-reflecting function, there can be mentioned an aluminum foil. It is also effective to dispose an upholstery adjacent to the side adjacent to said thin film.

The second aspect of the present invention is directed to a heat-shielding method which comprises forming a metallic pigment-containing coating film having an IR-reflecting function on one side of a coated plate and disposing said coated plate in a position such that said coating film is on the side not exposed to infrared radiation. When this invention is applied to an automotive body, said metallic pigment-containing coating film having an IR-reflecting function is disposed on the inner side of the body.

The metallic pigment-containing layer mentioned above includes, for example, a leafing aluminum and/or non-leafing aluminum-containing film. Further, the upholstery may be disposed adjacent to the surface carrying said coating film. The coated product formed by whichever of the above methods exhibits a significant heat-barrier effect.

The third aspect of the present invention is directed to a car upholstery comprising a layer having an IR-reflecting function on its surface which is to confront the car body. The above layer having an IR-reflecting function comprises a thin plate, preferably, an aluminum foil or a leafing aluminum-containing coating film. The car upholstery of this invention is particularly effective when used as a roof panel.

### BRIEF DESCRIPTION OF THE DRAWINGS

FIG. 1 is a sectional view showing an example of the coated plate obtainable by the heat-shielding method according to the first aspect of the invention;

FIG. 2 is a sectional view showing a thermometric test box relevant to the first aspect of the invention;

FIG. 3 is a sectional view showing an example of the coated product obtainable by the heat-shielding method according to the second aspect of the invention;

FIG. 4 is a sectional view showing a thermometric test box relevant to the second aspect of the invention;

FIG. 5 is a sectional view showing the car upholstery according to the third aspect of the invention as installed in a car body; and

FIG. 6 is a sectional view showing a thermometric test box for use in the evaluation of the heat-barrier efficiency of said upholstery.

### BRIEF DESCRIPTION OF THE NUMERIC SYMBOLS

1. substrate

2. thin plate

3. primer coating layer

4. intermediate coating layer

5. top coating layer

6. body

7. frame

8. testpiece

9. 10. 11. thermocouple

12. thermometer

13. infrared lamp

21. coated product

22. substrate

23. metallic pigment-containing layer

24. primer layer

25. intermediate coating layer

26. top coating layer

30. test box

31. body

32. frame

33. testpiece

34. 35. 36. thermocouple

37. thermometer

38. infrared lamp

41. automotive body

42. roof panel

43. upholstery

44. substrate

45. IR-reflecting layer

46. roof upholstery

47. aluminum sheet

48. test box

49. body

50. frame

51. coated shell plate

52. cover

53. thermocouple

54. infrared lamp

### DETAILED DESCRIPTION OF THE INVENTION

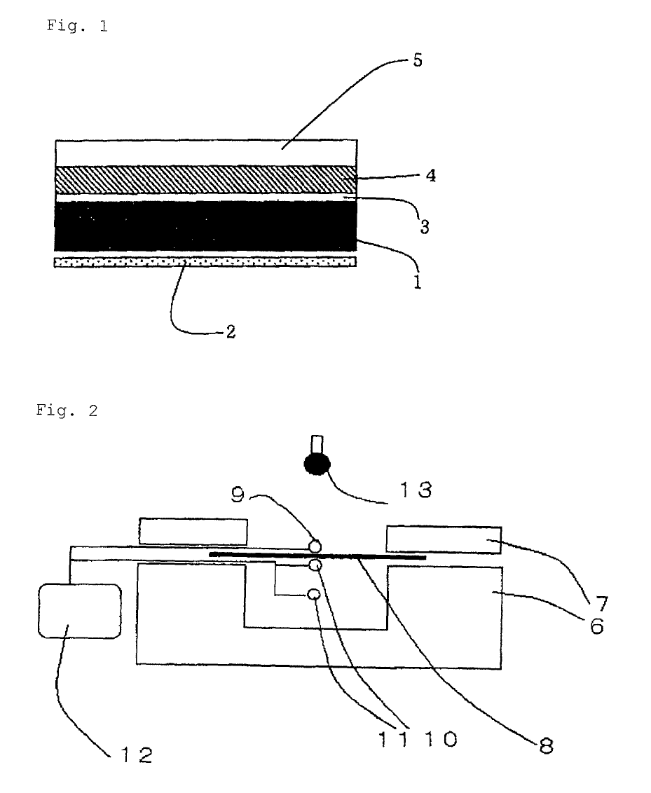

The first aspect of the present invention is now described in detail, reference being had to FIG. 1.

FIG. 1 is a cross-section view showing a coated plate as obtainable by the heat-shielding method according to the first aspect of the invention. In accordance with the first aspect of the invention, a thin plate 2 having an infrared radiation (IR)-reflecting function is disposed adjacent to the reverse side of a coated plate which has been fabricated by forming a primer coating layer 3, an intermediate coating layer 4 and a top coating layer 5 serially on one side of a substrate 1. Optionally, a layer similar to said primer layer 3 may be formed on the reverse side of said substrate 1.

The resulting coated product is disposed in such a position that sunlight will be incident on the coating layer side (from the top side of the view). Then, the sunlight transmitting through the coating layers and substrate 1 is reflected by the thin plate 2 so that the thermal energy of the solar radiation is not transferred to the reverse side of the sheet 2 (the bottom side in the view) . The thin plate 2 may be made of any material having an IR-reflecting function. The term “IR-reflecting function” means that the light reflectance of a surface in the wavelength region of 350 to 2500 nm as measured in accordance with JIS A5759 is not less than 20%, preferably 50 to 90%.

As the material having an IR-reflecting function, there can be mentioned aluminum foil, aluminum sheet, and stainless steel foil, among others. There can also be used the laminated sheet prepared by laminating an aluminum or stainless steel foil or the like onto a plastic or other substrate sheet or by vapor deposition of aluminum on such a substrate. In lieu of aluminum, chromium may be used in said vapor deposition, or a tin-plated sheet may also be used.

The thickness of the thin plate 2 is preferably such that its portion having said IR-reflecting function is at least 0.01 μm thick, more preferably at least 0.1 μm thick. The upper limit of thickness depends on the shape of substrate 1 and cannot be stated in general terms but when the substrate has a curved surface as in the case of an automotive body, the limit is about 1 mm and when it is an architectural siding, for instance, the limit is about 10 mm.

The thin plate 2 is disposed adjacent to the substrate 1. The term “adjacent” covers various modes of adjacency, for example direct bonding to substrate 1, bonding to substrate 1 through a coating layer or a heat insulating layer, or interposition between substrate 1 and an upholstery (not shown), for instance, and means that in order to express its IR-reflecting function, the thin plate 2 is disposed in close proximity with the substrate 1, for example within the distance of 0 to 10 cm.

In accordance with the first aspect of the present invention, the heat-shielding effect is not sacrificed even when an upholstery is disposed on the face side of the thin plate 2. Therefore, the method according to the first aspect of the invention is advantageous in that the heat-barrier effect can be expressed because designing of the coated surface is not subject to restriction and the room or car interior decoration is not impeded at all, either.

The substrate 1 is most often made of a metallic material, for example a steel plate, e.g. a galvanized steel plate, or an aluminum plate, which are in use for automotive bodies, roofing materials, warehouse sidings, etc., although the substrate may be made of a plastic resin, tile material, glass, or other ceramic material.

In FIG. 1, the primer layer 3, intermediate coating layer 4 and top coating layer 5 are successively formed on the substrate sheet 1 but this construction is not an exclusive choice. In the coating of truck body shells or architectural members, for instance, the intermediate coating layer 4 may be omitted. Conversely in the coating of an automotive body, an additional top coating layer (not shown) may be further superimposed on the top coating layer 5 and/or a heat insulating layer (not shown) for enhancing the heat-barrier effect may be interposed between the primer layer 3 and intermediate coating layer 4. (The heat insulating layer mentioned just above means a layer formed by using a material containing a heat-insulating material, such as hollow beads). Furthermore, the primer coating layer 3 may be formed not only on one side of the substrate 1 but also on the other side as well.

The coating compositions for use in the construction of the respective layers mentioned above may all be the conventional ones but a still more improved heat-barrier effect can be obtained by using the so-called heat barrier coating. Such heat barrier coatings include the coating containing pigments having high light reflectance within the wavelength region of 350 to 2500 nm as measured by the procedure directed in JIS A 5759.

The pigment having a high reflectance value for light includes white pigments which reflect all light within the above wavelength range. The light reflectance of pigments can be increased by the subtractive process using cyan, magenta and yellow pigments in a suitable combination. The combination of a magenta pigment with a cyan pigment, in particular, is preferred because the reflectance in the infrared region of the spectrum can be markedly increased.

Provided that the above requirements are met, the types of pigments which can be used are not restricted but the following pigments, among others, can be used with advantage. Thus, the inorganic pigment which can be used includes but is not limited to iron oxide, lead oxide, strontium chromate, titanium dioxide, cadmium yellow, cadmium red, chrome yellow, chrome green, cobalt green, ultramarine, Prussian blue, cobalt blue, etc. and the organic pigment includes phthalocyanine green, chlorinated phthalocyanine green, phthalocyanine blue, copper phthalocyanine blue, metal-free phthalocyanine blue, indanthrene blue, dioxazine violet, cinncassia red and so on.

Aside from the above pigments, extenders such as calcium carbonate, barium sulfate, clay, talc, etc. may also be added and depending on uses, rust-preventive pigments such as zinc dust, zinc chromate, ammonium phosphate, zinc phosphate, etc. and luster pigments such as aluminum flakes, perlescent pigments, white mica, glass beads, etc. can also be formulated. The pigment content of the coating, as expressed in the pigment weight content (PWC), is preferably 2.5 to 50 weight %.

The vehicle for dispersing the pigment includes the well-known acrylic resin, epoxy resin, polyamide resin, polyurethane resin, polyester resin, polybutadiene resin, etc. and the modification products of such resins.

The heat-shielding method according to the first aspect of the present invention is now described with reference to its application to the roof panel for an automotive body.

The primer layer 3 is preferably formed from a cationic electrodepositioncoating. In this case, the vehicle is preferably a cation-modified epoxy resin from the standpoint of corrosion resistance and throwing power. This resin is neutralized with an acid and used as a water-soluble coating.

The cation-modified epoxy resin mentioned above can be obtained by subjecting an epoxy resin to epoxy ring-opening reaction with an amine compound, such as a primary, secondary or tertiary amine.

The starting epoxy resin includes but is not limited to polyphenol-polyglycidyl ether type epoxy resins obtainable by reacting a polyphenol such as bisphenol A, bisphenol F, bisphenol S, phenol novolac and cresol novolac with epichlorohydrin.

This resin can be used after chain extension with a bifunctional polyester polyol or polyether polyol, a bisphenol compound, a dibasic carboxylic acid or the like.

Furthermore, prior to said epoxy ring-opening reaction with an amine, a monohydroxy compound such as 2-ethylhexanol, nonylphenol, ethylene glycol mono-2-ethylhexyl ether, propylene glycol mono-2-ethylhexyl ether or the like may be added to some of the epoxy rings for molecular weight or amine equivalent adjustment, amelioration of thermal flow characteristics, or other purposes.

The amine which can be used for the epoxy ring-opening and introduction of an amino group includes primary, secondary or tertiary amines, such as butylamine, octylamine, diethylamine, dibutylamine, methylbutylamine, monoethanolamine, diethanolamine, N-methylethanolamine, triethylamine acid salts, N,N-dimethylethanolamine, etc. Optionally, a tertiary amine can be used in the form of a salt with the acid used as the neutralizer.

Ketimine-blocked primary amino-containing secondary amines such as aminoethylethanolamine methylisobutyl ketimine or the like can also be used. It is necessary that these amines be used in at least equimolar amounts relative to the epoxy ring in order to cleave all the epoxy rings.

The number average molecular weight of said cation-modified epoxy resin is preferably within the range of 1500 to 5000. When the average number molecular weight is less than 1500, the cured coating film tends to be poor in solvent resistance and corrosion resistance. When it exceeds 5000, the viscosity of the resin solution can hardly be controlled to make synthesis difficult and the ease of handling in the emulsification and dispersion of the resulting resin tends to be sacrificed. In addition, the fluidity in thermal curing becomes poor to considerably impair the appearance of the coating film.

To a water-soluble vehicle comprising said cation-modified epoxy resin, there is added a dispersion of the pigment in, for example, a quaternized ammonium-modified epoxy resin. In addition, an extender, a rust-preventive pigment, an organic solvent and a surfactant, among others, may be added where necessary.

The above cationic electrodepositioncoating is used in combination with a known crosslinking agent such as a blocked polyisocyanate. This blocked polyisocyanate is a polyisocyanate, such as tolylene diisocyanate, isophorone diisocyanate, hexamethylene diisocyanate or the like, which has been blocked with a blocking agent which undergoes dissociation at a given temperature, for example 120 to 150° C., such as methanol, ethanol, diethanolamine, an oxime, ε-caprolactam or the like.

The vehicle for use in the formation of said intermediate coating layer 4 is preferably a polyester-melamine resin or an alkyd-melamine resin. As the constituent monomers of such resin, there can be mentioned trimethylolpropane, neopentyl glycol, phthalic anhydride, isophthalic acid, hexahydrophthalic acid, adipic acid and ε-caprolactone. The pigment is not particularly restricted but the heat-barrier effect can be improved by using a coating containing a pigment capable of reflecting light within said wavelength region.

As the vehicle for the coating to constitute said top coating layer 5, an alkyd-melamine resin or a polyester-melamine resin can be used with advantage for solid-color expression or an acrylic-melamine resin or the like can be used with advantage for metallic color expression or clear coating. Whether in the solid color system or in the metallic color system, the pigment that can be used is not particularly restricted so that a maximum freedom in design can be insured.

The coating compositions for said respective layers, except for the case in which the primer layer 3 is formed from a cationic electrodepositioncoating, may be any of the organic solvent type, the water-based type and the powder type. The coating method may also be liberally selected from among spray coating, brush coating, dip coating, roll coating, flow coating, and so on.

The typical process for practicing the heat-shielding method of the invention is as follows. Thus, the automotive body (substrate 1) is first subjected to alkali degreasing, cleaning, and chemical conversion treatment and, then, dipped in an electrocoating bath to form a primer layer 3 all over the body surface. The coated body is cleaned with water and cured at 120 to 180° C.

Then, the intermediate coating layer 4 and the top coating layer 5 are successively built up by the spray coating technique. Curing may be carried out independently for each layer but the 2-coat, 1-bake method is preferably used to concurrently cure the top coating layer 5 and clear coating layer.

Moreover, for the purpose of enhancing the heat-barrier effect, an additional coating layer, such as a heat insulating layer, may be interposed between the primer layer 3 and the intermediate coating layer 4 or the number of such layers may be modified as necessary. The dry thickness of the primer coating layer 3 is at least 10 μm, preferably 10 to 30 μm, more preferably 15 to 20 μm. The dry thickness of the intermediate coating layer 4 and top coating layer 5 is 20 to 50 μm, preferably 30 to 40 μm.

On the automotive body thus coated, a 15 μm-thick aluminum foil is provisionally secured to the interior side of its roof panel by means of two-sided adhesive tapes and an upholstery is installed in such a manner that the aluminum foil is sandwiched between the roof panel and the upholstery. In this manner, the heat-shielding method according to the invention is completed. The upholstery to be used in this procedure is not particularly restricted as far as it is for automotive use. As an example, there can be mentioned a product molded from a thermoplastic resin foam as a substrate such as a polystyrene or polypropylene foam into a form complementary to the interior surface of the roof panel and surfaced with an urethane cushioning member and a woven fabric or the like in that order.

The second aspect of the present invention is now described in detail.

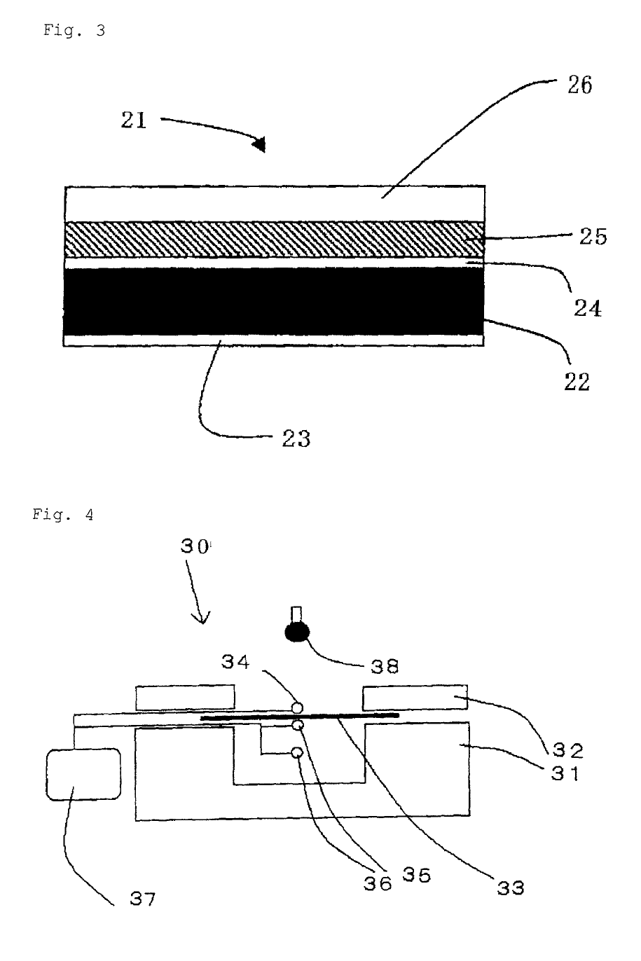

FIG. 3 is a cross-section view showing a coated product obtainable by the heat-shielding method according to the second aspect of the invention. The coated product 21 comprises a substrate 22 and a metallic pigment-containing layer 23 having an IR-reflecting function as formed on one side of said substrate 22. On the side of substrate 22 which is opposite to the metallic pigment-containing layer 23, there are a primer layer 24, an intermediate coating layer 25 and a top coating layer 26 formed in that order. The coated product 21 thus fabricated is disposed in such a position that the sunlight is incident on the top coating layer 26 (the top side as shown). In this arrangement, the heat is allowed to penetrate through the top coating layer 26, intermediate coating layer 25, primer layer 24 and substrate 22 but is reflected by the metallic pigment-containing layer 23 which has an IR-reflecting function. Therefore, the heat is not transferred to the reverse side (bottom side as shown) of the metallic pigment-containing layer 23.

The coating film constituting the metallic pigment-containing layer 23 is not particularly restricted only as far as it has an IR-reflecting function. The term “IR-reflecting function” means that the light reflectance of a surface in the wavelength region of 350 to 2500 nm as measured in accordance with JIS A5759 is not less than 20%, preferably 50 to 90%.

The coating film having said IR-reflecting function can be produced by using a coating containing a flaky aluminum pigment, for instance. Particularly preferred is a coating containing a leafing flaky aluminum pigment. The term “leafing flaky aluminum pigment” means a pigment comprising a flaky aluminum having a flake size of 1 to 150 μm as covered with a thin film of stearic acid or the like, and when the substrate 22 is coated with a coating containing such a pigment, the aluminum flakes float on the surface of the coating film to give an integral aluminum layer. As an alternative, an aluminum powder pigment having no leafing function may likewise be employed.

The thickness of the metallic pigment-containing layer 23 is preferably 1 to 100 μm, more preferably 10 to 50 μm. When the layer thickness is less than 1 μm, the heat-barrier effect is insufficient. On the other hand, when it exceeds 100 μm, troubles such as delamination may take place.

In accordance with the method according to the second aspect of the present invention, the heat-barrier effect is not sacrificed even when the upholstery is disposed adjacent to the metallic pigment-containing layer 23. Therefore, the method is advantageous not only in that an unrestricted freedom in design of the coated side is insured but also in that the desired heat-barrier effect can be realized without compromising the interior decoration.

The substrate 22 is mostly a metallic material and includes galvanized and other steel sheets and aluminum sheets for use as automotive bodies, roofing materials, warehouse sidings, etc. In addition, non-metallic substrates such as plastics, tiles, and glass or other ceramic substrates may also be used.

While the primer layer 24, intermediate coating layer 25 and top coating layer 26 are successively formed on the substrate 22 in FIG. 3, but this construction is not an exclusive choice. In the coating of truck body shells or architectural members, for instance, the intermediate coating layer 25 may be omitted. Conversely in the coating of an automotive body, an additional top coat (not shown) may be further superimposed on the top coating layer 26 and/or a heat insulating layer (not shown) for enhancing the heat-barrier effect may be interposed between the primer layer 24 and the intermediate coating layer 25. (The heat insulating layer mentioned just above means a layer formed by using a material containing a heat-insulating material, such as hollow beads) . Furthermore, the primer layer 24 may be formed not only on one side but also on the other side as well.

As the coating compositions for use in forming said respective layers 24 to 26, the known coatings can be used but a still more improved heat-barrier effect can be obtained by using the so-called heat barrier coating. Such heat barrier coatings include the coating containing pigments having high light reflectance within the wavelength region of 350 to 2500 nm as measured by the procedure directed in JIS A 5759.

The pigments having high light reflectance may be those mentioned hereinabove. The pigment content of the coating, as expressed in the pigment weight content (PWC), is preferably 2.5 to 50 weight %.

The vehicle for dispersing the pigment includes the well-known acrylic resin, epoxy resin, polyamide resin, polyurethane resin, polyester resin, polybutadiene resin, etc. and modification products of such resins. These resins can be used for the formation of said metallic pigment-containing layer 23.

The heat-shielding method according to the second aspect of the present invention is now described, taking its application to an automotive body as an example.

The primer layer 24 is preferably formed by a cationic electrodeposition technique. Specifically, the procedure described hereinabove can be employed.

The vehicle for use in the formation of said intermediate coating layer 25 is preferably a polyester-melamine resin or an alkyd-melamine resin. As the constituent monomers of such resins, there can be mentioned trimethylolpropane, neopentyl glycol, phthalic anhydride, isophthalic acid, hexahydrophthalic acid, adipic acid, ε-caprolactone, and soon. The pigment is not particularly restricted but an enhanced heat-barrier effect can be obtained by using a coating containing a pigment capable of reflecting light within said wavelength region.

As the vehicle for the coating to constitute said top coating layer 26, an alkyd-melamine resin or a polyester-melamine resin can be used with advantage for solid-color expression or an acrylic-melamine resin or the like can be used with advantage for metallic color expression or clear coating. Whether in the solid color system or in the metallic color system, the pigment that can be used is not particularly restricted so that a maximum freedom in design can be insured.

The form of the coating, excepting the case in which the primer layer 24 is a cationic electrodeposition film, may be any of the organic solvent type, water-based type, and powder type.

The coating method may also be any of spray coating, brush coating, dip coating, roll coating, casting and other coating methods.

A typical process for practicing the heat-shielding method of the invention is as follows. Thus, the substrate 22 is first subjected to alkali degreasing, cleaning, and chemical conversion treatment and, then, dipped in an electrocoating bath to form a primer layer 24 thereon. After cleaning with water and cured at 120 to 180° C.

Then, the intermediate coating layer 25 and top coating layer 26 are built up in that order by the spray coating technique. Curing may be carried out independently for each layer but the 2-coat, 1-bake method is preferably used to concurrently cure the top coating layer 26 and clear coating layer.

Moreover, for the purpose of enhancing the heat-barrier effect, an additional coating layer, such as a heat insulating layer, may be interposed between the primer layer 24 and the intermediate coating layer 25 or the number of such layers may be modified as necessary.

The dry thickness of the primer layer 24 is at least 10 μm, preferably 10 to 30 μm, more preferably 15 to 20 μm. The dry thickness of the intermediate coating layer 25 and of the top coating layer 26 is 20 to 50 μm, preferably 30 to 40 μm, each.

The metallic pigment-containing layer 23 may be formed by independently coating and drying either before or after the formation of said layers 24 to 26. However, the method of forming this layer 23 is not particularly restricted. Thus, the layer 23 can be formed in various modes, for example it can be formed after formation of another layer, such as the intermediate coating layer 25 and/or the top coating layer 26, and before curing of the same layer/layers and all the layers be cured in one operation or the metallic pigment-containing coating film 23 is used for the primer layer 24 and formed on both sides of the substrate 22.

The third aspect of the present invention is now described in detail.

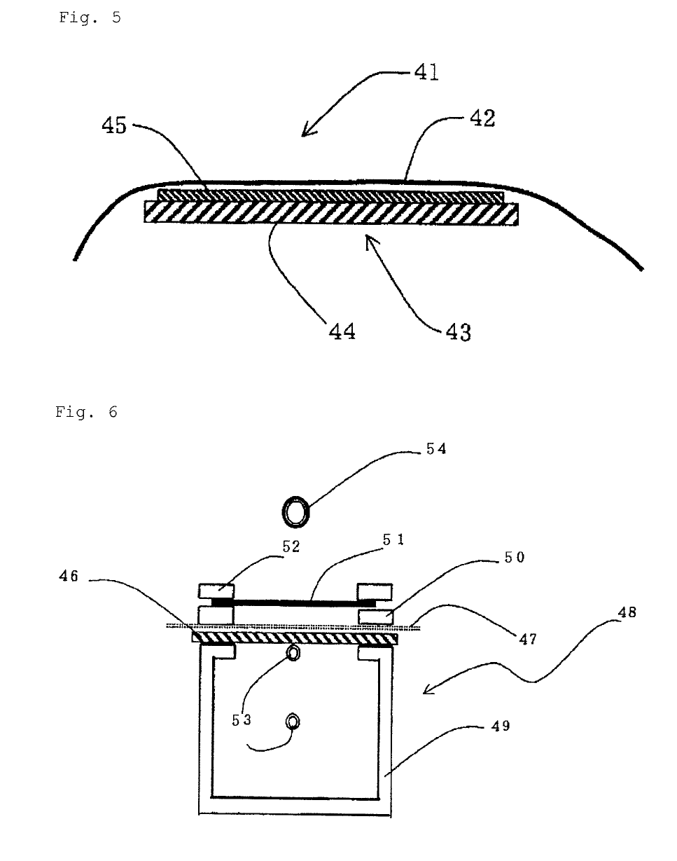

FIG. 5 is a cross-section view showing an exemplary mode of installation of a car upholstery in an automotive body. As shown, an upholstery 43 according to the present invention is attached to the roof panel 42 of an automotive body 41 by metal or plastic fastener means (not shown), such as bolts and nuts. The upholstery 43 comprises a substrate body 44 and an IR-reflecting layer 45. IR-reflecting layer 45 of the upholstery 43 is disposed in a position facing the roof panel 42 so that when the sunlight is incident on the top side of the roof panel 42, the thermal energy of the sunlight is intercepted by the IR-reflecting layer 45 so that the heat is not transferred to the substrate body 44.

The substrate body 44 of the upholstery 43 for use in the present invention can be produced by using a core member comprising a resin plate or a resin foam, a cushioning member laminated to the car-interior side of the core member, and a surfacing member covering said cushioning member. In case the core member serves as a cushioning material as well, the core member maybe directly covered with said surfacing member. The surfacing member maybe made of a low-foamed or non-foamed grade of the same material as the core material.

Furthermore, as the core member, an organic fiber or an inorganic fiber can be used either in lieu of the resin or in the form of a composite member comprising such a fiber and a resin. In addition, a layer having a damper or sound-absorbing function, such as a synthetic textile layer, may be built into the substrate body 44.

The resin plate mentioned above may be a plate which can be prepared by incorporating a filler such as talc, an organic foam powder, or an inorganic foam powder into a matrix resin such as propylene-ethylene block copolymer, ethylene-a-olefin copolymer or polycarbonate resin for weight reduction purposes and molding the mixture. As examples of the resin foam, there can be mentioned a modified polystyrene foam obtainable by copolymerizing styrene monomer with a copolymerizable monomer such as acrylic acid, methacrylic acid or maleic anhydride, a modified propylene foam obtainable by copolymerizing propylene as a main component with an olefin monomer, a modified phenylene ether resin foam, and a foam comprising a foamed mixture of such resins.

The thickness of the core member can be liberally selected according to the location of use of the upholstery; for example the thickness of the upholstery to be affixed to the roof panel 42 is preferably about 2 to 10 mm. As an example of said cushioning member, a urethane foam may be mentioned. As examples of said surfacing member, a grained or leather-like synthetic resin sheet, a woven fabric or a nonwoven fabric can be mentioned.

Two alternative methods are available for forming said IR-reflecting layer 45; one is a method in which a foil or thin plate having an IR-reflecting function is laminated onto the substrate body 44 and the other is a method comprising forming a coating film layer having an IR-reflecting function on the substrate body 44. The term “IR-reflecting function” means that the light reflectance of a surface in the wavelength region of 350 to 2500 nm as measured in accordance with JIS A5759 is not less than 20%, preferably 50 to 90%.

The first method comprising laminating a thin plate having an IR-reflecting function onto the substrate body 44 is first described. The thin plate is not particularly restricted as far as it has an IR-reflecting function and may for example be any of aluminum foil, aluminum sheet and stainless sheet. It also includes a laminate obtainable by laminating an aluminum foil or a stainless steel foil onto a plastic substrate or by vapor deposition of aluminum on a plastic substrate. In lieu of said aluminum, chromium may be used in said vapor deposition. A tin-plated plastic sheet may also be used.

As regards the thickness of said thin plate, the thickness of the IR-reflecting aluminum or other material is preferably at least 0.01 μm to 10 mm, more preferably 0.1 μm to 1 mm. When the thickness is less than 0.01 μm, the heat-barrier effect may be decreased. On the other hand, when the thickness is over 10 mm, the moldability is poor and the total weight of the automotive body is increased.

In laminating the IR-reflecting layer 45 to the substrate body 44, an adhesive compatible with the material of substrate body 44, such as an epoxy resin adhesive, a styrenic resin adhesive and a polyolefin adhesive, can be used. However, it is not necessary to insure a firm bond between the IR-reflecting layer 45 and the substrate body 44. Since the bond strength may be just sufficient to maintain the layer 45 until the upholstery 43 has been attached to the automotive body 41, such other means as fastening by means of metallic needles, partial thermal fusion, or application of a self-adhesive to the metal foil may be employed.

An alternative method comprises molding said substrate body 44 and IR-reflecting layer 45 in one operation. Thus, there is known the technique comprising pouring a mixture of a thermoplastic resin and a foaming agent onto an IR-reflecting layer 45 in a metal mold to effect lamination and foaming in one operation or the technique comprising pouring said mixture onto a surfacing member, then placing the IR-reflecting layer 45 in superimposition and causing foaming and curing reactions to take place concurrently under compression or decompression to provide a laminate.

Then, the other method comprising forming a coating film layer having an IR-reflecting function on the substrate 44 is now explained. The coating film layer having an IR-reflecting function can be formed by using a coating containing aluminum flakes, for instance. The particularly preferred coating contains a leafing flaky aluminum pigment.

The leafing flaky aluminum pigment comprises aluminum flakes having a major diameter of 1 to 150 μm and having their surfaces covered with stearic acid or other treating agents. When the substrate 44 is coated with a coating containing such a pigment, aluminum flakes float on the surface of the coating film layer to form an integral aluminum film. An aluminum powder pigment having non leafing function may also be used.

The dry thickness of the IR-reflecting layer 45 is preferably 1 to 100 μm, more preferably 10 to 50 μm. When the coating film thickness is less than 1 μm, the heat-barrier effect is insufficient. Selecting a thickness of more than 100 μm would only result in an economic disadvantage because of saturation of the heat-barrier effect.

The vehicle for use in dispersing said pigment can be selected from among the known alkyd resin, acrylic resin, epoxy resin, olefinic resin, polyamide resin, polyurethane resin, polyester resin, polybutadiene resin and modification products of such resins. It is necessary to select a resin showing good adhesion to the material of which the substrate 44 is made. Thus, when the substrate 44 is made of polypropylene, for instance, an olefinic resin may be judiciously chosen as the vehicle.

The form of the coating is preferably an organic solvent type or a water-based type, and the coating film is preferably formed by low-temperature curing or room-temperature drying. The coating method may be any of the spray coating, brush coating, dip coating, roll coating and casting methods.

As mentioned above, the upholstery 43 comprising the substrate 44 and IR-reflecting layer 45 is set in position with the IR-reflecting layer 45 adjoining to the automotive body 41. FIG. 5 shows the mode of attachment of the upholstery 43 to the roof panel 42 but the upholstery 43 can be similarly attached to the pillar or the door.

In accordance with the first aspect of the present invention wherein a thin plate having an IR-reflecting function is disposed adjacent to one side of a coated plate and in a position such that the surface of the shell plate which is adjacent to the thin plate is not directly exposed to infrared radiation, the thermal energy of the sunlight incident on the coated side of the coated plate penetrates through the coating layers and substrate but is reflected by said thin plate, with the result that the heat is not transferred to the reverse side of the thin plate. Therefore, the method according to this first aspect of the invention is advantageous in that a remarkable heat-barrier effect is obtained without restriction on the design of the coated surface or on the decoration of the room or car interior, particularly the decoration of the passenger car interior. Furthermore, the operating cost of the air conditioner is reduced to contribute to energy conservation.

In accordance with the second aspect of the present invention wherein a metallic pigment-containing coating film having an IR-reflecting function is formed on one side of a coated plate and in a position such that the coating film is not directly exposed to infrared radiation, the thermal energy of the sunlight incident on the coated side of the plate penetrates through the coating layers and substrate but is reflected by the metallic pigment-containing coating film, with the result that the heat is not transferred to the reverse side of the metallic pigment-containing layer. Therefore, the desired heat-barrier effect can be realized without compromising the design quality of the coated surface. Furthermore, when an upholstery is disposed on the metallic pigment-containing coating film side, the desired heat-shielding effect can be obtained without affecting the decoration of the room or car interior, particularly the car interior decoration. Furthermore, the operating cost of the air conditioner is reduced to contribute to energy conservation.

The car upholstery according to the third aspect of the present invention has an infrared-reflecting layer on the surface which is to confront a car body. Therefore, the thermal energy of the sunlight incident on the car body is reflected by the infrared-reflecting layer and hardly reaches the surfacing member of the upholstery. Therefore, the interior temperature buildup is suppressed to reduce the burden on the air conditioner so that the waste of energy can be prevented.

Furthermore, with the upholstery according to the third aspect of the invention wherein only that side of the upholstery which is not visible from within the car has been processed to impart a heat-barrier effect, the appearance of the car is not adversely affected unlike the case of using a heat barrier coating, with the result that not only an attractive car can be freely designed but the desired heat-barrier effect can be insured without compromising the aesthetic effect of the car interior.

### EXAMPLES

The following examples and comparative examples illustrate the present invention in further detail. In the examples, all percents (%) are by weight.

### Examples 1 and 2 and Comparative Examples 1 and 2

Steel testpieces degreased, cleaned, and subjected to chemical conversion treatment, 30 cm×40 cm×0.8 mm (thickness) each, were dip-coated in “POWER TOP V6” (Nippon Paint, gray electrodepositioncoating), cleaned with water, and cured at 150° C. The dry thickness of the electrodepositioncoating film (primer layer) was 20 μm.

Then, “ORGA P-2 8101” (Nippon Paint, intermediate coating) was spray-coated on the above electrodepositioncoating film and “ORGA P-2-1 202B” (Nippon Paint, top coating) was further spray-coated in superimposition. The two successive coats were cured at 150° C. in one operation to form a multi-layer coating film. The dry thickness of the intermediate coating film and of the top coating film was 40 μm each.

On the whole reverse surface of one of the above testpieces, a 15 μm-thick aluminum sheet was laminated and the resulting laminate was designated as the testpiece of Example 1. Then, a mat comprising a low-density urethane foam (upholstery) was laminated on the whole reverse surface of another testpiece laminated with a similar aluminum sheet in advance and the resulting laminate was designated as the testpiece of Example 2. A testpiece carrying no aluminum sheet was designated as the testpiece of Comparative Example 1 and the testpiece laminated with the above mat alone was designated as the testpiece of Comparative Example 2.

The light reflectance of the aluminum sheet was measured as directed in JIS A 5759 using a near-infrared spectrometer (“U-3500”, self-recording spectrophotometer, WI (iodine-tungsten) lamp, Hitachi, Ltd.). The 3-point average reflectance value was 82%.

Each of the above testpieces was set in the thermometric test box illustrated in FIG. 2 and evaluated for heat-barrier effect. The results are shown below in Tables 1 and 2.

The test box mentioned above comprises a body 6 made of a heat-insulating foam (polystyrene foam) and internally lined with aluminum as well as a frame 7 made of the same material.

The thermometric test was carried out as follows. First, the testpiece 8 was set on the body 6 and secured in position with the frame 7. Then, a thermocouple 9 for surface temperature measurement was set on the outer surface of the testpiece 8, a thermocouple 10 for reverse surface temperature measurement on the reverse side of the testpiece 8, and a thermocouple 11 for box center temperature measurement in the center of the box 6 so that each temperature could be read with the thermometer 12 (“HR 2500E”, Yokogawa Electric). A 100 V, 200 W infrared lamp 13 (“Toshiba Ref Lamp RF”, Toshiba) was set in a position 15 cm above the center of the testpiece 8 and the testpiece was irradiated with thermal rays. After 1 hour of irradiation, the respective temperatures were measured.

Since the thermometric test box used in the above examples and comparative examples was made of an aluminum-lined heat-insulating foam (polystyrene foam), the box had a good heat storage characteristic so that the internal temperature reading of the box was slightly exaggerated but a marked difference was found in box center temperature between Example 1, which showed 38.5° C., and Comparative Example 1, which had no aluminum sheet and showed 54.0° C.

### Example 3 and Comparative Example 3

Except that the thermometric test box made of a heat-insulating foam (polystyrene foam) without an aluminum lining was used, the heat barrier test was carried out in the same manner as in Example 1 and Comparative Example 1. The results are shown in Tables 1 and 2.

The thermometric test box used here had a comparatively efficient heat storage characteristic simulating a car interior but the effect of the aluminum sheet was quite amazing with the box center temperature being 37.5° C. in Example 3 versus 56.1° C. in Comparative Example 3 which had no aluminum sheet.

### Example 4 and Comparative Example 4

Using a black electrodepositioncoating of the following formulation, exposing the steel surface by removing the reverse side of the electrodeposition layer and laminating a 20 μm-thick aluminum tape (3-point average reflectance 81%) in lieu of the aluminum sheet, the testpiece of Example 4 was prepared in the same manner as in Example 3. On the other hand, lamination of the aluminum tape was omitted to prepare the testpiece of Comparative Example 4. The results of the heat-barrier test are shown in Tables 1 and 2.

Formulation for black electrodepositioncoating

| | |
|---|---|
| Amino-modified epoxy resin | 15.0% |
| (number average molecular weight 2200) | |
| Carbon black | 0.1% |
| Titanium white | 3.6% |
| Extender (Si-Al type) | 1.0% |
| Rust inhibitor (Pb-Si type) | 0.3% |
| Additives (neutralizer etc.) | 0.6% |
| Solvent (Cellosolve type) | 1.8% |
| Pure water | 77.6% |

### Examples 5 and 6 and Comparative Example 5

Except that a wooden box having a comparatively low heat insulation effect was used in lieu of the thermometric test box used in Example 1 and Comparative Example 1, the heat-barrier test was carried out in the same manner for Example 5. In addition, using said aluminum tape in lieu of the aluminum sheet used in Example 1 and the above wooden test box, the heat-barrier test was carried out in the same manner for Example 6. The results are shown in Tables 1 and 2.

### Examples 7 and 8 and Comparative Examples 6 and 7

Except that the following heat-barrier coating was substituted for the intermediate coating and top coating and a beads-containing heat-insulating layer of the following formulation was interposed between the substrate and the face-side primer layer, the heat-barrier test was carried out under otherwise the same conditions as in Example 5 for Example 7. In addition, the same heat-barrier coating was substituted for the primer layer of Example 7 as well to give the testpiece of Example 8; the aluminum sheet of Example 7 was omitted to give the testpiece of Comparative Example 6; and the aluminum sheet of Example 8 was omitted to give the testpiece of Comparative Example 7. These testpieces were subjected to the heat-barrier test. The results indicated that the use of the heat-barrier coating leads to a further improvement in heat-barrier performance as compared with the use of the regular coating.

Formulation for heat-barrier coating

| | |
|---|---|
| Amino-modified epoxy resin | 15.0% |
| (number average molecular weight 2200) | |
| Infrared-reflecting pigment | 0.4% |
| (a mixture of benzimidazolone, | |
| phthalocyanine and quinacridone pigments) | |
| Titanium white | 3.3% |
| Extender (Si-Al type) | 1.0% |
| Rust inhibitor (Pb-Si type) | 0.3% |
| Additives (neutralizer etc.) | 0.6% |
| Solvent (Cellosolve type) | 1.8% |
| Pure water | 77.6% |

Formulation for beads-containing heat-barrier coating

| | |
|---|---|
| Polyester resin | 29.8% |
| (number average molecular weight | |
| 2500, acid value 6, OH value 100) | |
| Butylated melamine resin | 10.0% |
| (number average molecular weight 1200) | |
| Epoxy resin | 4.0% |
| (epichlorohydrin-bisphenol type, | |
| number average molecular weight 900) | |
| Hollow beads (ceramics) | 11.0% |
| Surfactant (non-silicon type) | 0.2% |
| Solvent | 45.0% |
| (a mixture of aromatic hydrocarbon, | |
| ester and alcohol solvents) | |

It will be apparent from the above results that the testpieces having an aluminum sheet or tape laminated on the reverse side according to the examples have prominent heat-barrier properties as compared with the aluminum-free testpieces of the comparative examples.

TABLE 1

| Example | 1 | 2 | 3 | 4 | 5 | 6 | 7 | 8 |
|---|---|---|---|---|---|---|---|---|
| Top coating layer | OP-2-1 | OP-2-1 | OP-2-1 | OP-2-1 | OP-2-1 | OP-2-1 | Heat-barrier | Heat-barrier |
| | | | | | | | coating | coating |
| Intermediate layer | OP-2 | OP-2 | OP-2 | OP-2 | OP-2 | OP-2 | Heat-barrier | Heat-barrier |
| | | | | | | | coating | coating |
| Heat-insulating layer | — | — | — | — | — | — | Beads- | Beads- |
| | | | | | | | containing | containing |
| Face-side primer layer | Gray | Gray | Gray | Black | Gray | Gray | Gray | Heat-barrier |
| | electro- | electro- | electro- | electro- | electro- | electro- | electro- | coating |
| | coating | coating | coating | coating | coating | coating | coating | |
| Substrate | steel | steel | steel | steel | steel | steel | steel | steel |
| Reverse-side primer layer | Gray | Gray | Gray | — | Gray | Gray | Gray | Heat-barrier |
| | electro- | electro- | electro- | | electro- | electro- | electro- | coating |
| | coating | coating | coating | | coating | coating | coating | |
| Thin film | Al sheet | Al sheet and | Al sheet | Al tape | Al sheet | Al tape | Al sheet | Al sheet |
| | laminated | mat laminated | laminated | laminated | laminated | laminated | laminated | laminated |
| Surface temp. of testpiece | 101.7 | 103.5 | 105.0 | — | 97.5 | 102.8 | 91.5 | 86.3 |
| Reverse surface temp. | 100.2 | 105.0 | 107.5 | 106.9 | 96 | 97.1 | 87 | 80.1 |
| of testpiece | | | | | | | | |
| Box type | foam, | foam, | foam | foam | wood | wood | wood | wood |
| | inside: Al | inside: Al | | | | | | |
| Box center temp. | 38.5 | 42.7 | 37.5 | 34.8 | 25.1 | 26.1 | 24.0 | 24.0 |

In the Table, “OP-2-1” is “Orga P-2-1202B, and “OP-2” is “Orga P-2 8101”. Electrocoating means electrodepositioncoating.

TABLE 1

| Compar. Ex. | 1 | 2 | 3 | 4 | 5 | 6 | 7 |
|---|---|---|---|---|---|---|---|
| Top coating layer | OP-2-1 | OP-2-1 | OP-2-1 | OP-2-1 | OP-2-1 | Heat-barrier | Heat-barrier |
| | | | | | | coating | coating |
| Intermediate layer | OP-2 | OP-2 | OP-2 | OP-2 | OP-2 | Heat-barrier | Heat-barrier |
| | | | | | | coating | coating |
| Heat-insulating layer | — | — | — | — | — | Beads- | Beads- |
| | | | | | | containing | containing |
| Face-side primer layer | Gray | Gray | Gray | Black | Gray | Gray | Heat-barrier |
| | electro- | electro- | electro- | electro- | electro- | electro- | coating |
| | coating | coating | coating | coating | coating | coating | |
| Substrate | beads | beads | beads | beads | beads | beads | beads |
| Reverse-side primer layer | Gray | Gray | Gray | — | Gray | Gray | Heat-barrier |
| | electro- | electro- | electro- | | electro- | electro- | coating |
| | coating | coating | coating | | coating | coating | |
| Thin film | — | mat laminated | — | — | — | — | — |
| Surface temp. of testpiece | 98.3 | 102.0 | 103.5 | — | 93.0 | 86.6 | 80.3 |
| piece | | | | | | | |
| Reverse surface temp. of | 96.3 | 102.0 | 103.5 | 110.0 | 90.6 | 81.1 | 73.2 |
| testpiece | | | | | | | |
| Box type | foam, | foam, | foam | foam | wood | wood | wood |
| | inside: Al | inside: Al | | | | | |
| Box center temp. | 54.0 | 49.2 | 56.1 | 39.1 | 32.4 | 30.6 | 28.8 |

### Example 11 and Comparative Example 11

Steel testpieces degreased, cleaned, and subjected to chemical conversion treatment, 30 cm×40 cm×0.8 mm (thickness) each, were dip-coated in “POWER TOP V6” (Nippon Paint, gray electrodepositioncoating), cleaned with water, and cured at 150° C.

The dry thickness of the electrodepositioncoating film (primer layer) was 20 μm. Then, “ORGA P-2 8101” (Nippon Paint, intermediate coating) was spray-coated on the electrodepositioncoating film on one side and “ORGA P-2-1 202B” (Nippon Paint, top coating) was further spray-coated in superimposition. The two successive coats were cured at 150° C. in one operation to form a multi-layer coating film. The dry thickness of the intermediate coating film and of the top coating film was 40 μm each.

Then, the reverse side of the testpiece formed with the above multilayer film was spray-coated with a metallic pigment-containing coating of the following formulation, followed by room-temperature drying, to form a metallic pigment-containing layer having a dry thickness of 30 μm. In addition, a comparative testpiece not formed with a metallic pigment-containing layer was prepared as control.

The IR-reflecting function of the metallic pigment-containing layer was tested as directed in JIS A 5759 using a near-infrared spectrometer (“U-3500” self-recording spectrophotometer with a WI (iodine-tungsten) lamp, Hitachi, Ltd.). The 3-point average reflectance value was 72%.

Formulation for metal pigment-containing coating

| | |
|---|---|
| Acrylic resin | 22.2% |
| (number average molecular weight 6000) | |
| Butylated melamine resin | 9.5% |
| (number average molecular weight 1200) | |
| Aluminum flake (leafing aluminum) | 3.5% |
| Additives | 5.2% |
| (organic amide, amine, non-silicon | |
| surfactant, etc.) | |
| Solvent | 59.6% |
| (a mixture of aromatic hydrocarbon, | |
| ester and alcohol solvents) | |

Each of the testpieces was set in the thermometric test box shown in FIG. 4 and the heat barrier test was carried out. The results are shown below in Tables 3 and 4.

The above test box 30 comprises a body 31 made of a heat-insulating foam (polystyrene foam) and a frame 32 made of the same material.

To perform the thermometric test, the testpiece 33 was first set on the body 31 and secured in position with the frame 32. Then, a thermocouple 34 for surface temperature measurement was set on the outer surface of the testpiece 33, a thermocouple 35 for reverse surface temperature measurement on the reverse side of the testpiece 33, and a thermocouple 36 for box center temperature measurement in the center of the box 31 so that each temperature could be read with a thermometer 37 (“HR 2500E”, Yokogawa Electric). A 100 V, 200 W infrared lamp 38 (“Toshiba Ref Lamp RF”, Toshiba) was set in a position 15 cm above the center of the testpiece 13 and the testpiece was irradiated with thermal rays. After 1 hour of irradiation, the respective temperatures were measured.

The thermometric test box 30 used here are made of a heat-insulating foam (polystyrene foam) so that it has an efficient heat storage characteristic simulating a car interior.

### Example 12

Except that a silver base coating prepared by substituting a non-leafing aluminum flake for the aluminum flake in the leafing type coating used in Example 11, the procedure of Example 11 was repeated to prepare a test panel (the 3-point average light reflectance of the metallic pigment-containing layer: 58%) and the heat-barrier test was carried out under the same conditions as above. The results are shown in Table 3.

### Example 13

Except that the primer layer on one side of the substrate was formed from a leafing type coating in lieu of the electrodepositioncoating used in Example 11, the procedure of Example 11 was repeated to prepare a testpiece and the heat-barrier test was carried out in the same manner. The results are shown in Table 3.

### Examples 14 and 15 and Comparative Examples 12 and 13

Except that a heat-barrier coating of the following formulation was substituted for the intermediate coating layer and top coating layer and the following beads-containing heat insulating layer was interposed between the substrate and the face-side primer layer, the procedure of Example 11 was repeated to give a testpiece of Example 14 and the heat-barrier test was carried out. In addition, the same heat-barrier coating was further substituted for the primer layer as well of Example 14 to give the testpiece of Example 15; the metallic pigment-containing layer of Example 14 was omitted to give the testpiece of Comparative Example 12; and the metallic pigment-containing layer of Example 16 was omitted to give the testpiece of Comparative Example 13. Each testpiece was subjected to the heat-barrier test. The results are shown in Tables 3 and 4.

Formulation for heat-barrier coating

| | |
|---|---|
| Amino-modified epoxy resin | 15.0% |
| (number average molecular weight 2200) | |
| Infrared-reflecting pigment | 0.4% |
| (a mixture of benzimidazolone, | |
| phthalocyanine and quinacridone pigments) | |
| Titanium white | 3.3% |
| Extender (Si-Al type) | 1.0% |
| Rust inhibitor (Pb-Si type) | 0.6% |
| Solvent (Cellosolve type) | 0.3% |
| Additives (neutralizer etc.) | 1.8% |
| Pure water | 77.6% |

Formulation for beads-containing heat-barrier coating

| | |
|---|---|
| Polyester resin | 29.8% |
| (number average molecular weight | |
| 2500, acid value 6, OH value 100) | |
| Butylated melamine resin | 10.0% |
| (number average molecular weight 1200) | |
| Epoxy resin | 4.0% |
| (epichlorohydrin-bisphenol type, | |
| number average molecular weight 900) | |
| Hollow beads (ceramics) | 11.0% |
| Surfactant (non-silicon type) | 0.2% |
| Solvent | 45.0% |
| (a mixture of aromatic hydrocarbon, | |
| ester and alcohol solvents) | |

It will be apparent from the above results that the testpieces formed with a metallic pigment-containing layer on the reverse side of the substrate according to the examples showed a remarkably superior heat-barrier properties as compared with the testpieces not having a metallic pigment-containing layer according to the comparative examples.

TABLE 3

| Example | 9 | 10 | 11 | 12 | 13 |
|---|---|---|---|---|---|
| Top coating layer | OP-2-1 | OP-2-1 | OP-2-1 | Heat-barrier | Heat-barrier |
| | | | | coating | coating |
| Intermediate layer | OP-2 | OP-2 | OP-2 | Heat-barrier | Heat-barrier |
| | | | | coating | coating |
| Heat-insulating layer | — | — | — | Beads- | Beads- |
| | | | | containing | containing |
| Face-side primer | Gray | Gray | Leafing | Gray | Heat-barrier |
| layer | electrocoating | electrocoating | coating | electrocoating | coating |
| Substrate | steel | steel | steel | steel | steel |
| Reverse-side primer | Gray | Gray | — | Gray | Heat-barrier |
| layer | electrocoating | electrocoating | | electrocoating | coating |
| Metallic-pigment | Leafing | Silver-base | Leafing | Leafing | Leafing |
| containing layer | coating | coating | coating | coating | coating |
| Surface temp. of | 107.2 | 105.9 | 106.1 | 106.3 | 106.8 |
| testpiece | | | | | |
| Reverse surface | 106.7 | 105.5 | 105.3 | 105.8 | 106.4 |
| temp. of testpiece | | | | | |
| Box center temp. | 46.2 | 47.3 | 46.0 | 45.0 | 45.2 |

In the table, “OP-2-1” is “ORGA P-2-1 202b”, and “OP-2” is “ORGA P-2 8101”. Electrocoating means electrodepositioncoating.

TABLE 4

| Compar. Ex. | 8 | 9 | 10 |
|---|---|---|---|
| Top coating layer | OP-2-1 | Heat-barrier | Heat-barrier |
| | | coating | coating |
| Intermediate layer | OP-2 | Heat-barrier | Heat-barrier |
| | | coating | coating |
| Heat-insulating layer | — | Beads- | Beads- |
| | | containing | containing |
| Face-side primer | Gray | Gray | Heat-barrier |
| layer | electrocoating | electrocoating | coating |
| Substrate | steel | steel | steel |
| Reverse-side primer | Gray | Gray | Heat-barrier |
| layer | electrocoating | electrocoating | coating |
| Metallic-pigment | — | — | — |
| containing layer | | | |
| Surface temp. of | 104.4 | 103.1 | 103.7 |
| testpiece | | | |
| Reverse surface | 104.2 | 102.7 | 103.1 |
| temp. of testpiece | | | |
| Box center temp. | 51.3 | 49.2 | 48.6 |

### Example 21

Using a testpiece comprising a 0.1 mm-thick aluminum sheet 47 laid on top of a 0.3 mm-thick roof upholstery for taxicab use, the heat barrier test was carried out. In the test, the wooden thermometric test box 48 illustrated in FIG. 6 was used.

The testpiece was first set on the wooden body 49 and secured in position with a frame 50. Further on top of the testpiece, a coated shell plate 51 was placed and retained with a cover 52. The coated shell plate 51 was a conventional shell plate obtainable by coating a cold-rolled steel plate carrying a gray electrodepositioncoating film (“POWERCOAT V-6”, Nippon Paint) with an intermediate coating (“ORGA P-2 8101”, Nippon Paint) and a top coating (“ORGA P-2-1 202B”, Nippon Paint) in superimposition and cured. A thermocouple 53 for surface temperature measurement was disposed on the reverse side of the testpiece and another thermocouple in the center of the test box 48. The respective temperatures were measured with thermometers (“HR 2500E”, Yokogawa Electric) (not shown). In a position at 15 cm above the center of the coated shell plate 51, a 100 V, 200 W infrared lamp (“Toshiba Ref Lamp RF”, Toshiba) was set to irradiate the testpiece for 1 hour and the heat-barrier performance was evaluated.

The temperature of the reverse side of the testpiece was found to be 34.9° C. and the temperature of the box center was 24.9° C. In contrast, when the roof upholstery 46 was not used but the coated shell plate 51 only was set and the temperature measurement was carried out under the same conditions as above, the temperature of the reverse side of the coated shell plate 51 was 83.7° C. and the temperature in the center of the box was 32.6° C., indicating that the radiant heat conditions were comparable to those in mid-summer in Kanto District.

### Example 22

Except that a 7 mm-thick roof upholstery for passenger car use was substituted for said roof upholstery 46, the heat-barrier performance was evaluated as in Example 21. As a result, the temperature of the reverse side of the testpiece was 35.4° C. and the temperature in the center of the box was 24.2° C.

### Example 23

Except that the thermometric test box 48 made of a plastic foam and internally lined with an aluminum tape was used in lieu of the wooden test box 48, the heat barrier test was carried out in the same manner as in Example 21. As a result, the temperature of the reverse side of the testpiece was found to be 45.7° C. and the temperature in the center of the box to be 35.2° C.

### Example 24

Except that the thermometric test box 48 made of a foam and internally lined with an aluminum tape was used in lieu of the wooden test box 48, the heat barrier test was carried out in the same manner as in Example 22. As a result, the temperature of the reverse side of the testpiece was found to be 44.2° C. and the temperature in the center of the box to be 32.2° C.

### Comparative Examples 21 and 22

In Comparative Example 21, the aluminum sheet was not used but only the same taxicab roof upholstery as used in Example 21 was used. In Comparative Example 22, only the same passenger car roof upholstery as used in Example 22 was used. The heat barrier test was carried out under the same conditions as above. In Comparative Example 21, the temperature of the reverse side of the testpiece was 53.1° C. and the temperature in the center of the box was 28.9° C. In Comparative Example 22, the temperature of the reverse side of the testpiece was 48.2° C. and the temperature in the center of the box was 26.2° C.

### Comparative Examples 23 and 24

Except that a wooden thermometric test box 48 made of a foam and internally lined with an aluminum tape was substituted for the wooden thermometric test box 48, the heat-barrier performance was evaluated in the same manner as in Comparative Example 21 for Comparative Example 23 and in the same manner as in Comparative Example 22 for Comparative Example 24. In Comparative Example 23, the temperature of the reverse side of the testpiece was 63.3° C. and the temperature in the center of the box was 43.1° C. In Comparative Example 24, the temperature of the reverse side of the testpiece was 58.9° C. and the temperature in the center of the box was 38.0° C.

It will be apparent from the above results that when an aluminum sheet 47 is disposed on the coated shell plate 51 side of the roof upholstery 46 as in the examples, the heat-shielding effect is high even under the mid-summer solar heat conditions so that the cooling efficiency can be improved. On the other hand, when the roof upholstery only is installed, the heat-barrier properties is low as can be seen from the results of the comparative examples.

1. A heat-shielding method
which comprises disposing a thin plate having an IR-reflecting function adjacent to one side of a coated plate and disposing said coated plate in a position such that the surface adjacent to said thin plate is on the side not exposed to infrared light.

2. A heat-shielding method for car interior
which comprises disposing a thin plate having an IR-reflecting function on the inner surface of a car body.

3. The heat-shielding method according to claim 1
wherein said thin plate having an IR-reflecting function is an aluminum foil.

4. The heat-shielding method according to claim 2
wherein said thin plate having an IR-reflecting function is an aluminum foil.

5. The heat-shielding method according to claim 1
wherein an upholstery is disposed adjacent to the side on which said thin plate has been disposed.

6. The heat-shielding method according to claim 2
wherein an upholstery is disposed adjacent to the side to which said thin plate has been disposed.

7. A heat-shielding method
which comprises forming a metallic pigment-containing coating film having an IR-reflecting function on one side of a coated plate and disposing said coated plate in a position such that said coating film is on the side not exposed to infrared light.

8. A heat-shielding method for car interior
which comprises forming a metallic pigment-containing coating film having an IR-reflecting function on the inner surface of a car body.

9. The heat-shielding method according to claim 7
wherein said metallic pigment-containing coating film is a leafing aluminum and/or non-leafing aluminum-containing coating film.

10. The heat-shielding method according to claim 8
wherein said metallic pigment-containing coating film is a leafing aluminum and/or non-leafing aluminum-containing coating film.

11. The heat-shielding method according to claim 7
wherein an upholstery is disposed adjacent to the side on which said coating film has been disposed.

12. The heat-shielding method according to claim 8
wherein an upholstery is disposed adjacent to the side on which said coating film has been disposed.

13. A coated product as formed by the heat-shielding method according to claim 7.

14. A coated product as formed by the heat-shielding method according to claim 8.

15. A car upholstery comprising a layer having an IR-reflecting function on its surface which is to confront a car body.

16. The car upholstery according to claim 15
wherein said layer having an IR-reflecting function comprises a thin plate.

17. The car upholstery according to claim 15
wherein said layer having an IR-reflecting function comprises an aluminum foil.

18. The car upholstery according to claim 16
wherein said layer having an IR-reflecting function comprises an aluminum foil.

19. The car upholstery according to claim 15
wherein said layer having an IR-reflecting function comprises a leafing aluminum-containing coating film.

20. The car upholstery according to claim 15
wherein said upholstery is for car roof use.
